(19) United States
(12) Patent Application Publication
(10) Pub. No.: US 2025/0162601 A1
(43) Pub. Date: May 22, 2025

(54) ESTIMATION OF DRIVER INTERACTION BASED TUNING PARAMETERS FOR AUTOMATED DRIVING OR DRIVER ASSISTANCE

(71) Applicant: QUALCOMM Incorporated, San Diego, CA (US)

(72) Inventors: Sibylle Tanja REBER, Gröbenzell (DE); Mazen Medhat Mohamed El-Sayed NASSAR, München (DE); Jan VEEN, Hallbergmoos (DE); Ahmed Ehab Sadek Sayed KAMAL, München (DE); Benjamin GAUDSZUN, Bibertal OT Schneckenhofen (DE)

(21) Appl. No.: 18/511,364

(22) Filed: Nov. 16, 2023

(51) Int. Cl. B60W 50/08; B60W 60/00

(52) U.S. Cl. CPC B60W 50/085; B60W 60/0053; B60W 2520/10; B60W 2520/105; B60W 2540/10; B60W 2540/12; B60W 2540/18; B60W 2552/00; B60W 2556/45

(57) ABSTRACT

In some aspects, a device associated with a vehicle may obtain data relating to driver interaction with the vehicle. The device may estimate one or more driver interaction parameters based on the data relating to the driver interaction with the vehicle. The device may update one or more tuning parameters associated with an automated driving or driver assistance feature based on the one or more driver interaction parameters, resulting in one or more updated tuning parameters. The device may cause the automated driving or driver assistance feature to be applied at the vehicle in accordance with the one or more updated tuning parameters. Numerous other aspects are described.

### FIELD OF THE DISCLOSURE

Aspects of the present disclosure generally relate to an automated and/or driver assistance system and, for example, to estimation of driver interaction based tuning parameters for automated driving or driver assistance.

### BACKGROUND

Autonomous driving systems are an emerging technology that allows a vehicle to operate without human input, following a pre-programmed route or responding to real-time environmental conditions. Driver assistance systems, such as an advanced driver assistance system (ADAS), include technologies that provide assistance to a driver of a vehicle, such as technologies to help drivers avoid collisions and/or accidents or otherwise make driving the vehicle 110 safer and/or more efficient. Autonomous driving systems and/or driver assistance systems (e.g., an ADAS) generally use a combination of sensors, cameras, and software algorithms to perceive the environment and make decisions based on the perceived environment. Autonomous driving and/or driver assistance technology may be designed to create a safer, more efficient, and more convenient mode of transportation that reduces the need for human intervention. The development of autonomous driving systems and driver assistance systems has been driven by a convergence of factors (e.g., advancements in sensor technology, artificial intelligence, and machine learning) that have enabled vehicles to sense and process information from the surrounding environment (e.g., road conditions, traffic, and pedestrians).

### SUMMARY

Some aspects described herein relate to a device associated with a vehicle. The device may include one or more memories and one or more processors coupled to the one or more memories. The one or more processors may be configured to cause the device to obtain data relating to driver interaction with the vehicle. The one or more processors may be configured to cause the device to estimate one or more driver interaction parameters based on the data relating to the driver interaction with the vehicle. The one or more processors may be configured to cause the device to update one or more tuning parameters associated with an automated driving or driver assistance feature based on the one or more driver interaction parameters, resulting in one or more updated tuning parameters. The one or more processors may be configured to cause the device to cause the automated driving or driver assistance feature to be applied at the vehicle in accordance with the one or more updated tuning parameters.

Some aspects described herein relate to a method performed by a device associated with a vehicle. The method may include obtaining, by the device, data relating to driver interaction with the vehicle. The method may include estimating, by the device, one or more driver interaction parameters based on the data relating to the driver interaction with the vehicle. The method may include updating, by the device, one or more tuning parameters associated with an automated driving or driver assistance feature based on the one or more driver interaction parameters, resulting in one or more updated tuning parameters. The method may include causing, by the device, the automated driving or driver assistance feature to be applied at the vehicle in accordance with the one or more updated tuning parameters.

Some aspects described herein relate to a non-transitory computer-readable medium that stores a set of instructions. The set of instructions, when executed by one or more processors of a device associated with a vehicle, may cause the device to obtain data relating to driver interaction with the vehicle. The set of instructions, when executed by one or more processors of the device, may cause the device to estimate one or more driver interaction parameters based on the data relating to the driver interaction with the vehicle. The set of instructions, when executed by one or more processors of the device, may cause the device to update one or more tuning parameters associated with an automated driving or driver assistance feature based on the one or more driver interaction parameters, resulting in one or more updated tuning parameters. The set of instructions, when executed by one or more processors of the device, may cause the device to cause the automated driving or driver assistance feature to be applied at the vehicle in accordance with the one or more updated tuning parameters.

Some aspects described herein relate to an apparatus for wireless communication. The apparatus may include means for obtaining data relating to driver interaction with a vehicle. The apparatus may include means for estimating one or more driver interaction parameters based on the data relating to the driver interaction with the vehicle. The apparatus may include means for updating one or more tuning parameters associated with an automated driving or driver assistance feature based on the one or more driver interaction parameters, resulting in one or more updated tuning parameters. The apparatus may include means for causing the automated driving or driver assistance feature to be applied at the vehicle in accordance with the one or more updated tuning parameters.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which an autonomous vehicle or a vehicle equipped with an advanced driver assistance system (ADAS) may operate, in accordance with the present disclosure.

FIG. 2 is a diagram of an example on-board system of an autonomous vehicle or a vehicle equipped with an ADAS, in accordance with the present disclosure.

FIG. 3 is a diagram illustrating example components of a device in accordance with the present disclosure.

FIGS. 4A-4B are diagrams illustrating an example associated with estimation of driver interaction based tuning parameters for automated driving or driver assistance.

FIG. 5 is a flowchart of an example process associated with estimation of driver interaction based tuning parameters for automated driving or driver assistance, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A vehicle may be equipped with an autonomous driving system and/or advanced driver assistance system (ADAS) that may include one or more features associated with automated driving and/or driver assistance. For example, such a feature may be an automated or assisted steering feature that may control or assist in controlling the lateral movement of the vehicle. In some examples, a feature associated with an automated driving or driver assistance system may be a driver-in-the-loop (DIL) feature. That is, the autonomous driving system or driver assistance system (e.g., ADAS) of the vehicle may activate the feature subject to DIL control of the feature. DIL is a mechanism in which control of the vehicle is transferred between automated control by an automated driving or driver assistance feature and manual control by the driver based on whether the driver is passively interacting with the vehicle or actively interacting with the vehicle.

In some examples, an automated or assisted steering feature that controls the lateral movement of the vehicle may be subject to DIL control. In such examples, when the automated or assisted steering feature is active, the feature may provide a torque on the steering wheel of the vehicle that can be felt by the driver. The driver is supposed to leave his/her hands on the steering wheel and let the torque applied to the steering wheel by the automated or assisted steering feature guide the steering wheel (and thus control the lateral movement of the vehicle). If the driver wishes to override the automated or assisted steering feature, the driver can actively steer and move/force the steering wheel into the position desired by the driver. The DIL control mechanism measures the steering wheel torque applied by the driver (and/or other signals/data related to driver interaction with the vehicle) while the automated or assisted steering feature is active and determines whether the driver is actively steering (e.g., to override the automated or assisted steering feature) or passively interacting with the steering wheel (e.g., allowing his/her hands to be guided by the movement of the steering wheel caused by the automated or assisted steering feature). In a case in which the driver is actively steering, the steering wheel torque applied by the automated or assisted steering feature may be ramped down so that the driver does not have to fight against the automated or assisted steering feature to control the steering wheel of the vehicle. In this case, once the driver stops actively steering, the DIL control mechanism may detect that the driver is passively interacting with the steering wheel and ramp the steering wheel torque applied by the automated or assisted steering feature back up to return control of the vehicle to the automated or assisted steering feature.

Different drivers may exhibit different behavior when holding (e.g., passively interacting with) or moving (e.g., actively interacting with) the steering wheel of a vehicle while an automated or assisted steering feature is active. For example, some drivers may rest their hands heavily on the steering wheel, while other drivers may only lightly touch or grasp the steering wheel. There is a wide span of steering wheel torques that may be applied by different drivers when the automated or assisted steering feature is active and the drivers are not actively steering. In cases in which other types of data relating to driver interaction with the vehicle are used for DIL control of an automated driving or driver assistance feature, there may be a similarly wide span between the data associated with different drivers. Therefore, it is difficult to tune DIL parameters such that the DIL fits all drivers well and detects driver interaction early enough for all drivers. Thus, DIL may be inaccurate for some drivers, resulting in false positives for active driving detection for some drivers and/or delayed active driving detection for some (other) drivers.

Various aspects relate to estimation of driver interaction based tuning parameters for automated driving or driver assistance. In some aspects, a device associated with a vehicle may obtain data relating to driver interaction with the vehicle. In some examples, the device may obtain the data relating to the driver interaction with the vehicle via online data collection while the vehicle is being driven. In some other examples, the device may obtain the data relating to the driver interaction with the vehicle via a vehicle-driver interaction sequence while the vehicle is stationary (e.g., not being driven). The device may estimate one or more driver interaction parameters based on the data relating to the driver interaction with the vehicle. For example, the one or more driver interaction parameters may include or relate to steering wheel torque values and/or other parameters associated with active steering by a driver of the vehicle and/or passive interaction with the steering wheel of the vehicle by the driver of the vehicle. The device may update one or more tuning parameters associated with an automated driving or driver assistance feature based on the one or more driver interaction parameters. For example, the one or more tuning parameters may be DIL tuning parameters. The device may cause the automated driving or driver assistance feature to be applied at the vehicle in accordance with the one or more updated tuning parameters. For example, control of the vehicle may be transferred between the automated driving or driver assistance feature and the driver based at least in part on detection of passive or active driver interaction with the vehicle using the one or more updated tuning parameters.

Particular aspects of the subject matter described in this disclosure can be implemented to realize one or more of the following potential advantages. In some examples, by estimating one or more driver interaction parameters based on data relating to driver interaction with a vehicle and updating one or more tuning parameters associated with an automated driving or driver assistance feature, the device associated with the vehicle can update the tuning parameters (e.g., DIL tuning parameters) with tuning parameters specific to the driver of the vehicle. By causing the automated driving or driver assistance feature to be applied in accordance with the updated tuning parameters, the feature is applied with increased accuracy. For example, applying the feature subject to DIL control using the updated tuning parameters may result in increased accuracy, such as by reduced false positives for detection of active driver interaction with a steering wheel of the vehicle and/or reduced delays for detection of active driver interaction with the steering wheel of the vehicle, as compared with tuning parameters that are not updated based on driver interaction data associated with the driver of the vehicle.

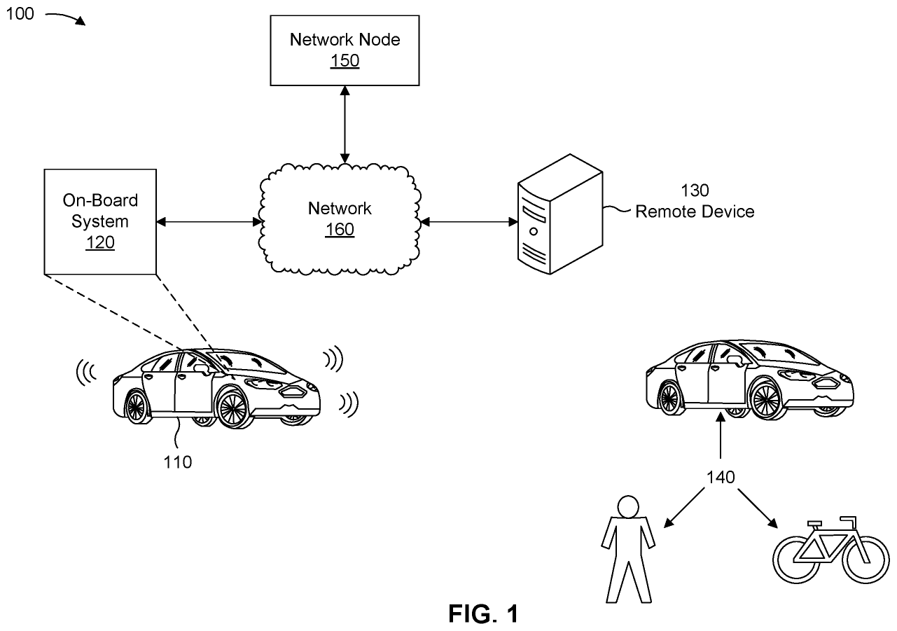

FIG. 1 is a diagram of an example environment 100 in which an autonomous vehicle or a vehicle equipped with an ADAS may operate, in accordance with the present disclosure. As shown in FIG. 1, the environment 100 may include, for example, a vehicle 110, an on-board system 120 of the vehicle 110, a remote device 130, a network node 150, and a network 160. Devices of the environment 100 may interconnect via wired connections, wireless connections, or a combination of wired and wireless connections. As further shown in FIG. 1, the environment 100 may include one or more objects 140 that the vehicle 110 is configured to detect (e.g., using the on-board system 120).

In some aspects, the vehicle 110 may include any moving form of conveyance that is capable of carrying one or more human occupants and/or cargo and that is powered by any suitable energy source. For example, the vehicle 110 may include a land vehicle (e.g., a car, a truck, a van, or a train), an aircraft (e.g., an unmanned aerial vehicle), and/or a watercraft. In the example depicted in FIG. 1, the vehicle 110 is a land vehicle, and is shown as a car. Furthermore, the vehicle 110 is an autonomous vehicle in the example of FIG. 1. For example, an autonomous vehicle (AV) is a vehicle having a processor, programming instructions, and drivetrain components that are controllable by the processor without requiring a human operator. An autonomous vehicle may be fully autonomous in that the autonomous vehicle does not require a human operator for most or all driving conditions and functions, or an autonomous vehicle may be semi-autonomous in that a human operator may be required in certain conditions or for certain operations, or that a human operator may override the autonomous system of the autonomous vehicle and take control of the autonomous vehicle. In some aspects, an autonomous vehicle (e.g., the vehicle 110) may support one or more DIL features. For example, the autonomous vehicle (e.g., the vehicle 110) may support one or more automated driving features (e.g., an automated steering feature and/or other automated features) that are subject to DIL control. Additionally, or alternatively, the vehicle 110 may be equipped with an ADAS that supports one or more safety features and/or technologies to help drivers avoid collisions and/or accidents (e.g., adaptive cruise control, lane departure warning, automatic emergency braking) or otherwise make driving the vehicle 110 safer and/or more efficient. In some aspects, an ADAS (e.g., the ADAS of the vehicle 110) may support one or more DIL features. For example, the ADAS may support one or more automated driving or driver assistance features (e.g., an automated or assisted steering feature and/or other automated or assisted features) that are subject to DIL control.

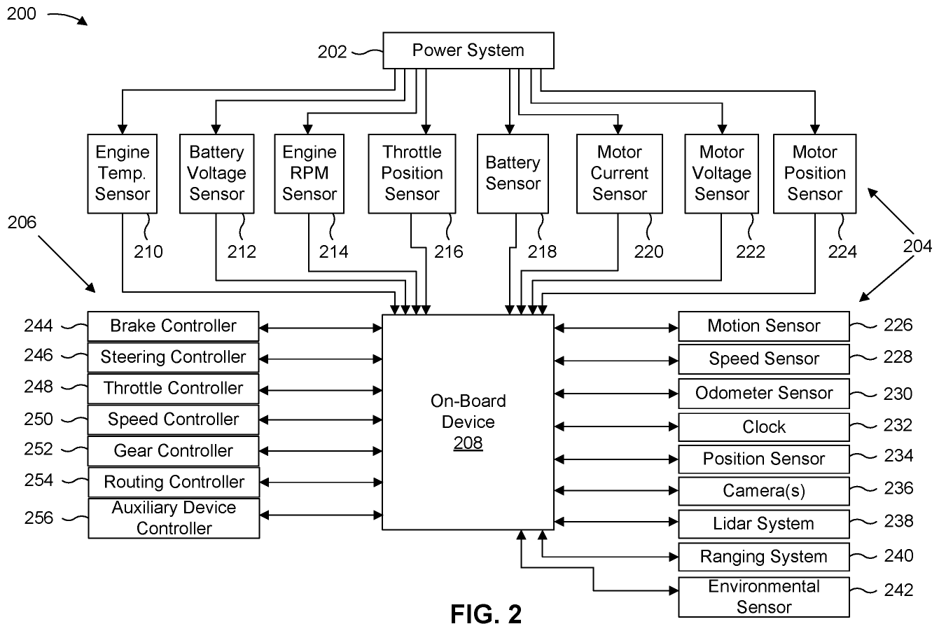

As shown in FIG. 1, the vehicle 110 may include an on-board system 120 that is integrated into and/or coupled with the vehicle 110. In general, the on-board system 120 may be used to control the vehicle 110, to sense information about the vehicle 110 and/or an environment in which the vehicle 110 operates, to detect one or more objects 140 in proximity of the vehicle, to provide output to or receive input from an occupant of the vehicle 110, and/or to communicate with one or more devices remote from the vehicle 110, such as another vehicle and/or the remote device 130. Accordingly, as described herein, the vehicle 110 may be an ego vehicle, which refers to the subject vehicle that is using autonomous driving technology, an ADAS, and/or one or more sensors (e.g., cameras, lidars, and radars) to perceive a surrounding environment and make decisions related to a trajectory, speed, and/or actions of the vehicle 110 on the road. The on-board system 120 is described in more detail below in connection with FIG. 2.

In some aspects, the vehicle 110 may travel along a road in a semi-autonomous or autonomous manner. The vehicle 110 may be configured to detect objects 140 in proximity of the vehicle 110. An object 140 may include, for example, another vehicle (e.g., an autonomous vehicle or a non-autonomous vehicle that requires a human operator for most or all driving conditions and functions), a cyclist (e.g., a rider of a bicycle, electric scooter, or motorcycle), a pedestrian, a road feature (e.g., a roadway boundary, a lane marker, a sidewalk, a median, a guard rail, a barricade, a sign, a traffic signal, a railroad crossing, or a bike path), and/or another object that may be on a roadway or in proximity of a roadway, such as a tree or an animal. In some aspects, to detect objects 140, the vehicle 110 may be equipped with a camera-based vision system and/or one or more sensors, such as a lidar system. In some aspects, the camera-based vision system and/or the one or more sensors may be included in another system other than the vehicle 110, such as a robot, a satellite, and/or a traffic light.

In some aspects, the one or more sensors may provide object detection data, such as information about a detected object 140 (e.g., information about a distance to the object 140, a speed of the object 140, and/or a direction of movement of the object 140) to one or more other components of the on-board system 120. Additionally, or alternatively, the vehicle 110 may transmit the object detection data to the remote device 130 (e.g., a server, a cloud computing system, and/or a database) via the network 160 (e.g., via the network node 150). The remote device 130 may be configured to process the object detection data and/or to transmit a result of processing the object detection data to the vehicle 110 via the network 160 (e.g., via the network node 150). In some examples, the remote device 130 may be a server device.

In some aspects, the network node 150 includes one or more devices configured to receive, generate, store, process, and/or provide information related to one or more aspects described herein. For example, the network node 150 may include a base station (a Node B, a gNB, and/or a 5G node B (NB), among other examples), a user equipment (UE), a relay device, a network controller, an access point, a transmission reception point (TRP), an apparatus, a device, a computing system, and/or another suitable processing entity configured to perform one or more aspects described herein. For example, in some aspects, the network node 150 may include an aggregated base station and/or one or more components of a disaggregated base station (e.g., a central unit, a distributed unit, and/or a radio unit) that enables the on-board system 120 to communicate over the network 160 (e.g., to invoke or otherwise utilize processing capabilities associated with the remote device 130).

The network 160 includes one or more wired and/or wireless networks. For example, the network 160 may include a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. In some aspects, the network 160 enables communication among the devices of environment 100.

In some aspects, as described herein, the on-board system 120 or the remote device 130 may be configured to obtain data relating to driver interaction with the vehicle 110; estimate one or more driver interaction parameters based on data relating to the driver interaction with the vehicle 110; update one or more tuning parameters associated with an automated driving or driver assistance feature based on the one or more driver interaction parameters, resulting in one or more updated tuning parameters; and cause the automated driving or driver assistance feature to be applied at the vehicle 110 in accordance with the one or more updated tuning parameters.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example on-board system 200 of an autonomous vehicle or a vehicle equipped with an ADAS, in accordance with the present disclosure. In some aspects, the on-board system 200 may correspond to the on-board system 120 included in the vehicle 110, as described above in connection with FIG. 1. As shown in FIG. 2, the on-board system 200 may include one or more of the illustrated components 202-256. The on-board system 200 may include, for example, a power subsystem 202, a sensor subsystem 204, a control subsystem 206, and/or an on-board device 208. The components of the on-board system 200 may communicate via a bus (e.g., one or more wired and/or wireless connections), such as a controller area network (CAN) bus.

The power subsystem 202 may be configured to generate mechanical energy for the vehicle 110 to move the vehicle 110. For example, the power subsystem 202 may include an engine that converts fuel to mechanical energy (e.g., via combustion) and/or a motor that converts electrical energy to mechanical energy.

The sensor subsystem 204 may include one or more sensors configured to detect operational parameters of the vehicle 110 and/or environmental conditions in an environment in which the vehicle 110 operates (e.g., surrounding the vehicle 110). For example, the sensor subsystem 204 may include an engine temperature sensor 210, a battery voltage sensor 212, an engine rotations per minute (RPM) sensor 214, a throttle position sensor 216, a battery sensor 218 (e.g., to measure current, voltage, and/or temperature of a battery), a motor current sensor 220, a motor voltage sensor 222, a motor position sensor 224 (e.g., a resolver and/or encoder), a motion sensor 226 (e.g., an accelerometer, gyroscope and/or inertial measurement unit), a speed sensor 228, an odometer sensor 230, a clock 232, a position sensor 234 (e.g., a global navigation satellite system (GNSS) sensor and/or a global positioning system (GPS) sensor), one or more cameras 236, a lidar system 238, one or more other ranging systems 240 (e.g., a radar system and/or a sonar system), and/or an environmental sensor 242 (e.g., a precipitation sensor and/or ambient temperature sensor).

The control subsystem 206 may include one or more controllers configured to control operation of the vehicle 110. For example, the control subsystem 206 may include a brake controller 244 to control braking of the vehicle 110, a steering controller 246 to control steering and/or direction of the vehicle 110, a throttle controller 248 and/or a speed controller 250 to control speed and/or acceleration of the vehicle 110, a gear controller 252 to control gear shifting of the vehicle 110, a routing controller 254 to control navigation and/or routing of the vehicle 110 (e.g., using map data), and/or an auxiliary device controller 256 to control one or more auxiliary devices associated with the vehicle 110, such as a testing device, an auxiliary sensor, and/or a mobile device transported by the vehicle 110.

The on-board device 208 may be configured to receive sensor data from one or more sensors included in the sensor subsystem 204 and/or to provide commands to one or more controllers included in the control subsystem 206. For example, the on-board device 208 may control operation of the vehicle 110 by providing a command to a controller included in the control subsystem 206 based on sensor data received from a sensor included in the sensor subsystem 204. In some aspects, the on-board device 208 may be configured to process sensor data to generate a command. The on-board device 208 may include memory, one or more processors, an input component, an output component, and/or a communication component, as described elsewhere herein.

As an example, the on-board device 208 may receive navigation data, such as information associated with a navigation route from a start location of the vehicle 110 to a destination location for the vehicle 110. In some aspects, the navigation data is accessed and/or generated by the routing controller 254. For example, the routing controller 254 may access map data and identify possible routes and/or road segments that the vehicle 110 can travel to move from the start location to the destination location. In some aspects, the routing controller 254 may identify a preferred route, such as by scoring multiple possible routes, applying one or more routing techniques (e.g., minimum Euclidean distance, Dijkstra's algorithm, and/or Bellman-Ford algorithm), accounting for traffic data, and/or receiving a user selection of a route, among other examples. The on-board device 208 may use the navigation data to control operation of the vehicle 110. As the vehicle travels along the route, the on-board device 208 may receive sensor data from various sensors in the sensor subsystem 204. For example, the position sensor 234 may provide geographic location information to the on-board device 208, which may then access a map associated with the geographic location information to determine known fixed features associated with the geographic location, such as streets, buildings, stop signs, and/or traffic signals, which may be used to control operation of the vehicle 110.

In some aspects, the on-board device 208 may receive one or more images captured by one or more cameras 236, may analyze the one or more images (e.g., to detect object data), and may control operation of the vehicle 110 based on analyzing the images (e.g., to avoid detected objects). For example, the on-board device 208 may obtain, from the camera(s) 236, a series of images that depict a reference vehicle traveling along a road segment ahead of the vehicle 110, and the on-board device 208 may analyze the series of images to estimate a size of the reference vehicle and/or a position of the reference vehicle relative to the vehicle 110. The on-board device 208 may track a trajectory of the reference vehicle along the road segment ahead of the vehicle 110 based on the estimated size of the reference vehicle and/or the estimated position of the reference vehicle over the series of images and may estimate a surface geometry associated with the road segment ahead of the vehicle 110 based on the tracked trajectory of the reference vehicle. Accordingly, the on-board system 208 may generate one or more control signals (e.g., to control the vehicle 110, stay within a designated lane, avoid an obstacle, and/or plan a route) based on the estimated surface geometry associated with the road segment ahead of the vehicle 110.

In some aspects, the on-board device 208 may receive object data associated with one or more objects detected in a vicinity of the vehicle 110 and/or may generate object data based on sensor data. The object data may indicate the presence or absence of an object, a location of the object, a distance between the object and the vehicle 110, a speed of the object, a direction of movement of the object, an acceleration of the object, a trajectory (e.g., a heading) of the object, a shape of the object, a size of the object, a footprint of the object, and/or a type of the object (e.g., a vehicle, a pedestrian, a cyclist, a stationary object, or a moving object). The object data may be detected, for example, by one or more cameras 236 (e.g., as image data), the lidar system 238 (e.g., as lidar data) and/or one or more other ranging systems 240 (e.g., as radar data or sonar data). The on-board device 208 may process the object data to detect objects in proximity of the vehicle 110 and/or to control operation of the vehicle 110 based on the object data (e.g., to avoid detected objects).

In some aspects, the on-board device 208 may use the object data (e.g., current object data) to predict future object data for one or more objects. For example, the on-board device 208 may predict a future location of an object, a future distance between the object and the vehicle 110, a future speed of the object, a future direction of movement of the object, a future acceleration of the object, and/or a future trajectory (e.g., a future heading) of the object. For example, if an object is a vehicle and map data indicates that the vehicle is at an intersection, then the on-board device 208 may predict whether the object will likely move straight or turn. As another example, if the sensor data and/or the map data indicates that the intersection does not have a traffic light, then the on-board device 208 may predict whether the object will stop prior to entering the intersection.

The on-board device 208 may generate a motion plan for the vehicle 110 based on sensor data, navigation data, and/or object data (e.g., current object data and/or future object data). For example, based on current locations of objects and/or predicted future locations of objects, the on-board device 208 may generate a motion plan to move the vehicle 110 along a surface and avoid collision with other objects. In some aspects, the motion plan may include, for one or more points in time, a speed of the vehicle 110, a direction of the vehicle 110, and/or an acceleration of the vehicle 110. Additionally, or alternatively, the motion plan may indicate one or more actions with respect to a detected object, such as whether to overtake the object, yield to the object, pass the object, or the like. The on-board device 208 may generate one or more commands or instructions based on the motion plan, and may provide those command(s) to one or more controllers associated with the control subsystem 206 for execution.

In some aspects, an automated driving or driver assistance feature supported by the on-board system 200 may subject to DIL control. In such examples, the on-board device 208 may transfer control of the vehicle associated with the automated driving or driver assistance feature between the on-board system 200 (e.g., the control subsystem 206) and the driver of the vehicle based on the on-board device 208 determining whether driver interaction with the vehicle is passive or active. For example, in the case of an automated or assisted steering function supported by the on-board system 200, the on-board device 208 may transfer control away from the steering controller 246 (e.g., ramp down steering wheel torque provided by the steering controller 246) in connection with a determination (e.g., based on steering wheel torque values measured by a sensor in the sensor subsystem 204) that the driver is actively interacting with the steering wheel (e.g., actively steering). The on-board device 208 may transfer control to the steering controller 246 (e.g., ramp up steering wheel torque provided by the steering controller 246) in connection with a determination (e.g., based on steering wheel torque values measured by a sensor in the sensor subsystem 204) that the driver is passively interacting with the steering wheel.

As indicated above, FIG. 2 is provided as an example. Other examples may differ from what is described with regard to FIG. 2. The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more functions described as being performed by another set of components shown in FIG. 2. For example, although some components of FIG. 2 are primarily associated with land vehicles, other types of vehicles are within the scope of the disclosure.

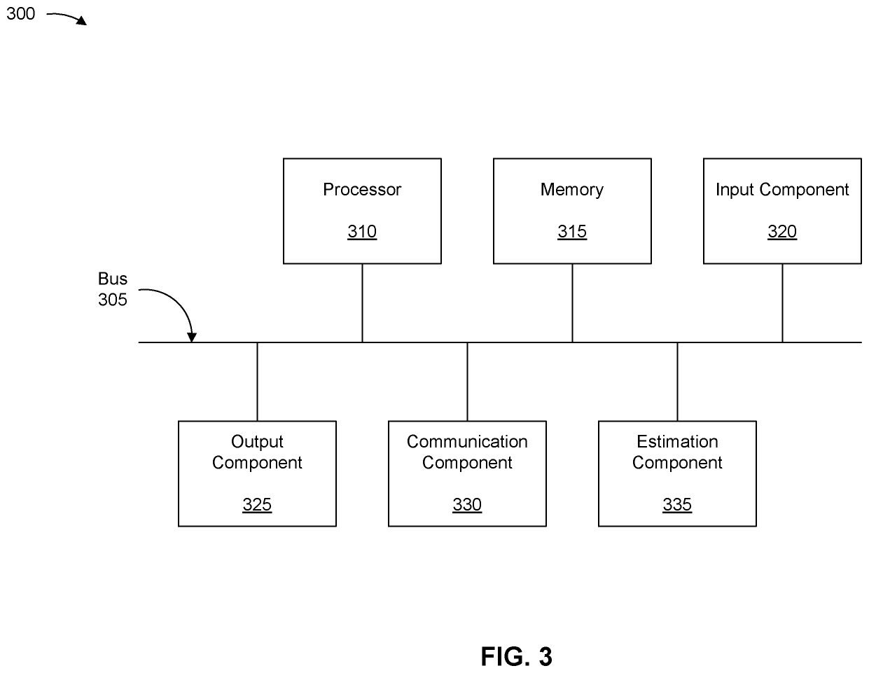

FIG. 3 is a diagram illustrating example components of a device 300, in accordance with the present disclosure. The device 300 may correspond to the on-board system 120, the remote device 130, or the network node 150 depicted in FIG. 1, the on-board system 200 or the on-board device 208 depicted in FIG. 2, and/or any other device, system, subsystem, or component described herein. In some aspects, the on-board system 120, the remote device 130, the network node 150, the on-board system 200, the on-board device 208, and/or other devices, systems, subsystems, or components described herein may include one or more devices 300 and/or one or more components of the device 300. As shown in FIG. 3, the device 300 may include a bus 305, a processor 310, a memory 315, an input component 320, an output component 325, a communication component 330, and/or an estimation component 335.

The bus 305 may include one or more components that enable wired and/or wireless communication among the components of the device 300. The bus 305 may couple together two or more components of FIG. 3, such as via operative coupling, communicative coupling, electronic coupling, and/or electric coupling. For example, the bus 305 may include an electrical connection (e.g., a wire, a trace, and/or a lead) and/or a wireless bus. The processor 310 may include a central processing unit, a graphics processing unit, a microprocessor, a controller, a microcontroller, a digital signal processor, a field-programmable gate array, an application-specific integrated circuit, and/or another type of processing component. The processor 310 may be implemented in hardware, firmware, or a combination of hardware and software. In some aspects, the processor 310 may include one or more processors capable of being programmed to perform one or more operations or processes described elsewhere herein.

The memory 315 may include volatile and/or nonvolatile memory. For example, the memory 315 may include random access memory (RAM), read only memory (ROM), a hard disk drive, and/or another type of memory (e.g., a flash memory, a magnetic memory, and/or an optical memory). The memory 315 may include internal memory (e.g., RAM, ROM, or a hard disk drive) and/or removable memory (e.g., removable via a universal serial bus connection). The memory 315 may be a non-transitory computer-readable medium. The memory 315 may store information, one or more instructions, and/or software (e.g., one or more software applications) related to the operation of the device 300. In some aspects, the memory 315 may include one or more memories that are coupled (e.g., communicatively coupled) to one or more processors (e.g., processor 310), such as via the bus 305. Communicative coupling between a processor 310 and a memory 315 may enable the processor 310 to read and/or process information stored in the memory 315 and/or to store information in the memory 315.

The input component 320 may enable the device 300 to receive input, such as user input and/or sensed input. For example, the input component 320 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 325 may enable the device 300 to provide output, such as via a display, a speaker, and/or a light-emitting diode. The communication component 330 may enable the device 300 to communicate with other devices via a wired connection and/or a wireless connection. For example, the communication component 330 may include a receiver, a transmitter, a transceiver, a modem, a network interface card, and/or an antenna.

The estimation component 335 may obtain data relating to driver interaction with the vehicle; estimate one or more driver interaction parameters based on the data relating to the driver interaction with the vehicle; and/or update one or more tuning parameters associated with an automated driving or driver assistance feature based on the one or more driver interaction parameters, resulting in one or more updated tuning parameters.

The device 300 may perform one or more operations or processes described herein. For example, a non-transitory computer-readable medium (e.g., memory 315) may store a set of instructions (e.g., one or more instructions or code) for execution by the processor 310. The processor 310 may execute the set of instructions to perform one or more operations or processes described herein. In some aspects, execution of the set of instructions, by one or more processors 310, causes the one or more processors 310 and/or the device 300 to perform one or more operations or processes described herein. In some aspects, hardwired circuitry may be used instead of or in combination with the instructions to perform one or more operations or processes described herein. Additionally, or alternatively, the processor 310 may be configured to perform one or more operations or processes described herein. Thus, aspects described herein are not limited to any specific combination of hardware circuitry and software.

In some aspects, device 300 may include means for obtaining data relating to driver interaction with the vehicle; means for estimating one or more driver interaction parameters based on the data relating to the driver interaction with the vehicle; means for updating one or more tuning parameters associated with an automated driving or driver assistance feature based on the one or more driver interaction parameters, resulting in one or more updated tuning parameters; and/or means for causing the automated driving or driver assistance feature to be applied at the vehicle in accordance with the one or more updated tuning parameters. In some aspects, the means for device 300 to perform processes and/or operations described herein may include one or more components of device 300 described in connection with FIG. 3, such as bus 305, processor 310, memory 315, input component 320, output component 325, communication component 330, and/or estimation component 335. Additionally, or alternatively, the means for device 300 to perform processes and/or operations described herein may include one or more components of the on-board system 200 described in connection with FIG. 2, such as the sensor subsystem 204, the control subsystem 206, and/or the on-board device 208, among other examples.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

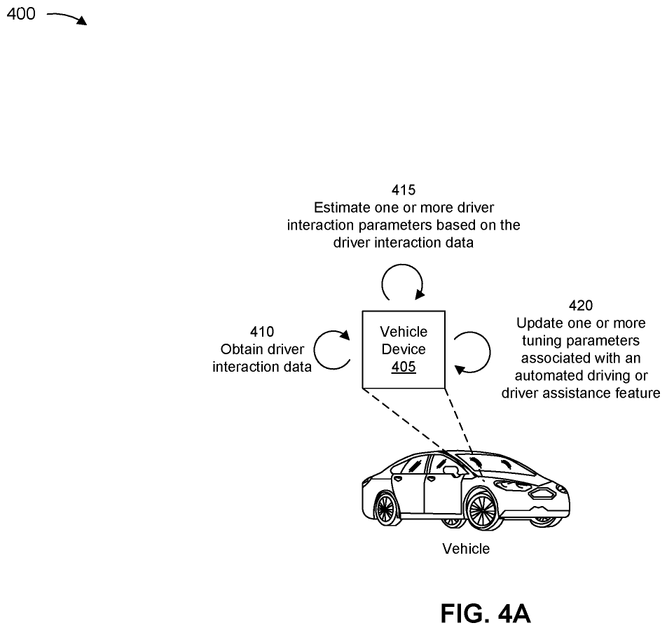

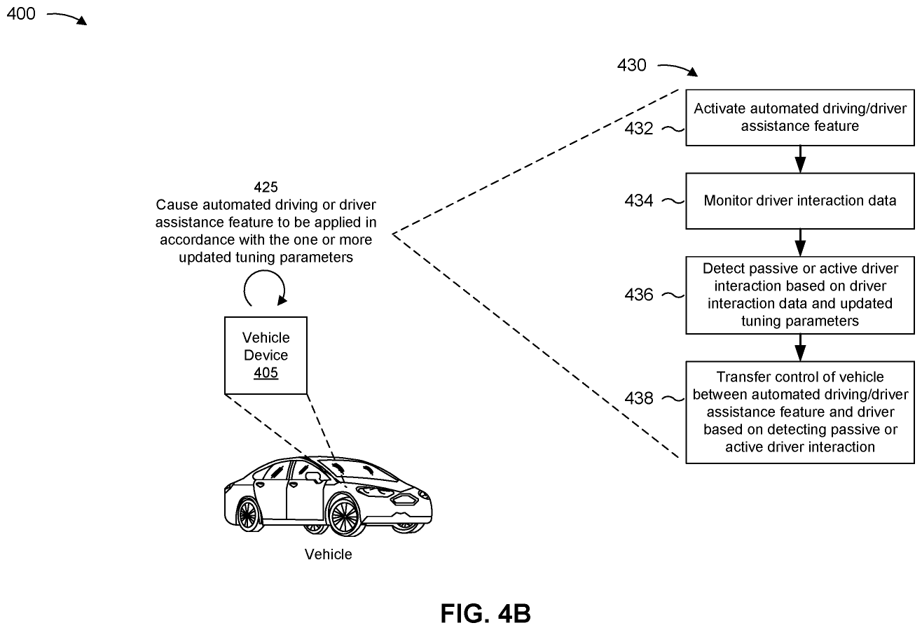

FIGS. 4A-4B are diagrams illustrating an example 400 associated with estimation of driver interaction based tuning parameters for automated driving or driver assistance. As shown in FIGS. 4A-4B, example 400 includes a vehicle (e.g., vehicle 110) and a vehicle device 405. The vehicle may be an autonomous driving vehicle or a vehicle equipped with an ADAS. For example, the vehicle may be equipped with an on-board system (e.g., on-board system 120 and/or on-board system 200) that supports autonomous driving and/or ADAS technology. The vehicle device 405 may be a device associated with the vehicle. In some aspects, as shown in FIGS. 4A-4B, the vehicle device 405 may be an on-board device (e.g., on-board device 208) or an on-board system (e.g., on-board system 120 and/or on-board system 200) of the vehicle. In some other aspects, the vehicle device 405 may be a remote device (e.g., remote device 130) associated with the vehicle, such as a server device in communication with an on-board system of the vehicle. Accordingly, operations described in connection with FIGS. 4A and 4B may be performed by an on-board device and/or on-board system of the vehicle, or may be performed by a remote device external to the vehicle.

As shown in FIG. 4A, and by reference number 410, the vehicle device 405 may obtain data relating to driver interaction with the vehicle (referred to herein as “driver interaction data”). The driver interaction data may include data relating to interactions of a particular driver (e.g., a current driver of the vehicle) with the vehicle. The driver interaction data may be collected by one or more sensors of the vehicle (e.g., one or more sensors in the sensor subsystem 204). In some aspects, the vehicle device 405 may obtain the driver interaction data by causing or controlling the one or more sensors to collect the driver interaction data. In some aspects, the vehicle device 405 may obtain the driver interaction data by receiving the driver interaction data from the one or more sensors. In some aspects (e.g., in a case in which the vehicle device 405 is a remote device), the vehicle device 405 may obtain the driver interaction data by receiving a transmission (or multiple transmissions) including the driver interaction data from another device (e.g., an on-board device) associated with the vehicle.

In some aspects, the vehicle device 405 may obtain the driver interaction data via online data collection while the vehicle is being driven. That is, the driver interaction data may be collected (e.g., by the one or more sensors and/or the vehicle device 405) while the vehicle is being driven. In some examples, the driver interaction data may be collected continuously while the vehicle is being driven. In some other examples, the driver interaction data may be collected periodically or responsive to certain trigger conditions (e.g., corresponding to target driving conditions) while the vehicle is being driven. In some examples, the driver interaction data may be collected while the driver is driving the vehicle, without the driver being aware of the driver interaction data being collected. In some aspects, the driver interaction data may be collected while the vehicle is being driven and while no automated driving or driver assistance (e.g., ADAS) feature is active. In some aspects, the driver interaction data may be collected while the vehicle is being driven and while a particular automated driving or driver assistance feature for which tuning parameters are being estimated/updated is not active. In some aspects, the driver interaction data may be collected while the vehicle is being driven both when the automated driving or driver assistance feature (e.g., for which tuning parameters are being estimated/updated) is active and when the automated driving or driver assistance feature is not active.

In some aspects, in a case in which the driver interaction data is obtained via online data collection while the vehicle is being driven, the estimation of one or more driver interaction parameters (discussed in connection with reference number 415) and the updating of one or more tuning parameters associated with an automated driving or driving assistance feature (discussed in connection with reference number 420) may also be performed by the vehicle device 405 online while the vehicle is being driven. In such examples, the vehicle device 405 may repeatedly (e.g., continuously, periodically, or responsive to certain trigger conditions) estimate the one or more driver interaction parameters based on the driver interaction data (discussed in connection with reference number 415) and update one or more tuning parameters associated with an automated driving or driving assistance feature based on the one or more driver interaction parameters (discussed in connection with reference number 420) to improve/adapt the tuning parameters (e.g., DIL tuning parameters) over the time period in which the vehicle is being driven. In this case, the updating of one or more tuning parameters may begin anew each time the vehicle is started/driven or may be combined with previously updated tuning parameters.

In some aspects, the driver interaction data (e.g., that is collected while the vehicle is being driven) may include one or more of driver steering data, brake input data, accelerator input data, and/or driver condition monitoring data, among other examples. The driver steering data may include steering wheel torque measurements (e.g., measurements of torques (at different times) applied to the steering wheel of the vehicle by the driver). The brake input may include measurements of a force or pressure applied to the brake pedal of the vehicle by the driver and/or measurements of an angle of the brake pedal of the vehicle. The accelerator input data may include measurements of a force or pressure applied to the accelerator pedal of the vehicle and/or measurements of an angle of the accelerator pedal of the vehicle.

In some aspects, the vehicle device 405 may sort the driver interaction data into different categories to be used for estimation of driver interaction parameters. The vehicle device 405 may categorize the driver interaction data into a plurality of data sets associated with different respective driving scenarios. That is, driver interaction data associated with different driving scenarios may be stored in separate datasets. In some examples, the vehicle device 405 may categorize the driver interaction data into different data sets based on whether or not the driver interaction with the vehicle is actively changing a motion of the vehicle (e.g., to distinguish between active and passive phases of driver interaction with the vehicle by the driver). In such examples, the driver interaction data may be sorted into a first dataset (or multiple first datasets) including driver interaction data associated with active interaction with the vehicle (e.g., active interaction with a steering wheel of the vehicle) by the driver, and a second data set (or multiple second datasets) including driver interaction data associated with passive interaction with the vehicle (e.g., passive interaction with the steering wheel of the vehicle) by the driver. Additionally, or alternatively, the vehicle device 405 may categorize the driver interaction data into different data sets based on different road geometries (e.g., straight driving and different curvature ranges). Additionally, or alternatively, the vehicle device 405 may categorize the driver interaction data into different data sets based on different speed ranges of the vehicle and/or different acceleration states of the vehicle (e.g., accelerating, decelerating, or steady state driving). Additionally, or alternatively, the vehicle device 405 may categorize the driver interaction data into different data sets based on different road conditions and/or environment conditions.

In some aspects, the vehicle device 405 may obtain the driver interaction data via a vehicle-driver interaction sequence that is performed while the vehicle is stationary (e.g., at a standstill). For example, the vehicle-driver interaction sequence may be used for offline collection of the driver interaction data while the vehicle is not being driven. In some examples, the vehicle-driver interaction sequence may be performed responsive to the driver of the vehicle explicitly activating the vehicle-driver interaction sequence. For example, the vehicle-driver interaction sequence may be performed (e.g., responsive to the driver activating the vehicle-driver interaction sequence) prior to the driver driving the vehicle. The vehicle-driver interaction sequence may include a sequence of interactions with the vehicle (e.g., with the steering wheel, the brake pedal, and/or the accelerator pedal, among other examples) to be performed by the driver. For example, the sequence of interactions may include active interactions with the vehicle (e.g., active steering of the steering wheel) and/or passive interactions with the vehicle (e.g., passively letting the driver's hands be guided by automated control of the steering wheel of the vehicle). In some examples, the vehicle-driver interaction sequence may include one or more actuators controlling movement of a portion of the vehicle (e.g., actuators of the steering controller 246 controlling the steering wheel of the vehicle) while the driver allows his/her hands to be guided by the movement of the portion of the vehicle (e.g., the steering wheel) without interfering with the movement. In such examples, the vehicle-driver interaction sequence may also include instructing the driver to perform one or more side tasks so that the driver does not concentrate on the movement controlled by the one or more actuators, but instead behaves as intuitively as possible. The driver input (e.g., driver steering input, driver break input, and/or driver accelerator input, among other examples) may be measured during the vehicle-driver interaction sequence to obtain the driver interaction data. That is, the driver interaction data may include measurements of the driver interactions with the vehicle in the vehicle-driver interaction sequence.

In some aspects, in a case in which the driver interaction data is obtained via the vehicle-driver interaction sequence while the vehicle is not being driven (e.g., stationary), the estimation of one or more driver interaction parameters (discussed in connection with reference number 415) and the updating of one or more tuning parameters associated with an automated driving or driving assistance feature (discussed in connection with reference number 420) may also be performed by the vehicle device 405 while the vehicle is not being driven. In such examples, the vehicle device 405 may estimate the one or more driver interaction parameters based on the driver interaction data (discussed in connection with reference number 415) and update one or more tuning parameters associated with an automated driving or driving assistance feature based on the one or more driver interaction parameters (discussed in connection with reference number 420) offline prior to the vehicle being driven by the driver. In some examples, the driver may be guided by the vehicle (e.g., controlled by the vehicle device 405) to interact with the vehicle during the vehicle-driver interaction sequence, as discussed above. In some other examples, the vehicle-driver interaction sequence may be performed by the vehicle (e.g., controlled by the vehicle device 405) as part of a service (e.g., at a garage) to tune the tuning parameters of an automated driving or driver assistance feature.

As further shown in FIG. 4A, and by reference number 415, the vehicle device 405 may estimate one or more driver interaction parameters based on the driver interaction data. In some aspects, the vehicle device 405 may estimate the one or more driver interaction parameters online while the vehicle is being driven. In some other aspects, the vehicle device 405 may estimate the one or more driver interaction parameters offline, while the vehicle is not being driven (e.g., while the vehicle is stationary).

In some aspects, the vehicle device 405 may estimate the one or more driver interactions by applying one or more estimation techniques to the collected driver interaction data. For example, the one or more estimation techniques applied to the driver interaction data may include one or more of linear regression, averaging, three sigma (and/or six sigma) calculation geometrical curve fitting, and/or machine learning based estimation, among other examples. In some aspects, in a case in which the driver interaction data is categorized into a plurality of datasets (e.g., associated with different driving scenarios), the vehicle device 405 may estimate respective driver interaction parameters for one or more datasets of the plurality of datasets. In some examples, the vehicle device 405 may estimate one or more respective driver interaction parameters for each dataset of the plurality of datasets. In some examples, one or more datasets of the plurality of datasets may be saved to be used for estimation of the driver interaction parameters, and one or more datasets of the plurality of datasets may be discarded (e.g., not used for estimation of the driver interaction parameters). In this case, the vehicle device 405 may estimate one or more respective driver interaction parameters for each dataset that is not discarded. In some aspects, the vehicle device 405 may estimate one or more driver interaction parameters associated with active interaction with the vehicle (e.g., with the steering wheel of the vehicle) by the driver and/or one or more driver interaction parameters associated with passive interaction with the vehicle (e.g., with the steering wheel of the vehicle) by the driver.

The driver interaction data in a dataset may be a driver input signal including measurements of driver interactions with the vehicle (e.g., steering wheel torque measurements, driver break input measurements, driver accelerator input measurements, and/or driver condition monitoring inputs) at various time points. In some aspects, the vehicle device 405 may estimate driver interaction parameters and/or a driver interaction parameter signal of interest for a dataset by applying an estimation technique (e.g., averaging, linear regression, three sigma, geometric curve fitting, or machine learning based estimation, among other examples) to the driver input signal included in the dataset.

In some aspects, the driver interaction parameters and/or a driver interaction parameter signal of interest may be intermediate parameters or values that can be used to determine tuning parameters (e.g., DIL tuning parameters) for an automated driving or driver assistance feature. In some examples, the one or more driver interaction parameters may include one or more wheel torque values (and/or parameters relating to wheel torque values) associated with active steering by a driver of the vehicle, and one or more wheel torque values (and/or parameters relating to wheel torque values) associated with passive interaction with the steering wheel of the vehicle by the driver of the vehicle. For example, the wheel torque values may be average wheel torque values estimated from the driver input wheel torque values in respective datasets associated with active steering and passive interaction (or values resulting from other estimation techniques performed on the driver input wheel torque values). Additionally, or alternatively, the driver interaction parameters may include derivatives (e.g., rates of change) of driver input signals (e.g., derivatives associated with driver input wheel torque signals for active steering and passive interaction) and/or integrals of driver input signals (e.g., integrals associated with driver input wheel torque signals for active steering and passive interaction), among other examples. In some examples, the wheel torque values, derivatives associated with the wheel torque values, and/or integrals associated with the wheel torque values may be parameters used to estimate DIL tuning parameters for an automated or assisted steering feature.

In some aspects, the one or more driver interaction parameters may include tuning parameters (e.g., driver-specific DIL tuning parameters) for an automated driving or driver assistance feature that are estimated based on the driver interaction data. For example, the one or more driver interaction parameters may include one or more thresholds, gains, integral parameters, derivative parameters, and/or rate limits, among other examples that can be used (e.g., in logic associated with the feature) for detecting active or passive interaction with the vehicle by the driver. The integral parameters may include one or more parameters associated with integrating driver input data and/or parameters estimated from driver input data for detecting active or passive interaction with the vehicle by the driver. For example, a decay rate parameter may be associated with an integral calculation performed to detect active or passive interaction with the vehicle by the driver. The derivative parameters may include one or more parameters associated with calculating derivatives (e.g., rates of change) from driver input data and/or parameters estimated from driver input data for detecting active or passive interaction with the vehicle by the driver. In some examples, the one or more driver interaction parameters may include one or more thresholds, gains, integral parameters, derivative parameters, and/or rate limits, among other examples associated with wheel torque based detection of active or passive interaction with the vehicle by the driver.

As further shown in FIG. 4A, and by reference number 420 the vehicle device 405 may update one or more tuning parameters associated with an automated driving or driver assistance feature based one the one or more driver interaction parameters, resulting in one or more updated tuning parameters. In some aspects, the tuning parameters may be DIL tuning parameters associated with the automated driving or driver assistance feature. For example, the tuning parameters (e.g., the updated tuning parameters) may be associated with detecting transfer of control of the vehicle between the automated driving or driver assistance feature and the driver of the vehicle (e.g., based on detection of passive interaction or active interaction with the vehicle by the driver). In some aspects, the automated driving or driver assistance feature may be an automated or assisted steering feature that controls lateral movement of the vehicle.

In some aspects, the one or more updated tuning parameters may include one or more updated thresholds, gains, integral parameters, derivative parameters, or rate limits associated with detecting active or passive interaction with the vehicle by a driver of the vehicle. In some examples, the one or more updated tuning parameters may include one or more updated thresholds, gains, integral parameters, derivative parameters, or rate limits associated with steering wheel torque based detection of active or passive interaction with the steering wheel of the vehicle by a driver of the vehicle. For example, the updated thresholds may include one or more updated wheel torque thresholds and/or one or more updated integral thresholds (e.g., for comparing with an integrated value associated with driver input wheel torques). The updated gains may include one or more updated gains for weighting values used for detecting active or passive interaction. The updated integral parameters and/or derivative parameters may include one or more updated parameters (such as a decay rate parameter) associated with calculating integrals and/or derivatives used for detecting active or passive interaction. The updated rate limits may include one or more updated rate limits to be compared with rates of change (e.g., derivatives) of driver wheel torque inputs for detecting active or passive interaction.

The vehicle device 405 may update current tuning parameters (e.g., DIL tuning parameters) for the automated driving or driver assistance feature based on the estimated driver interaction parameters, resulting in the updated tuning parameters. In some examples, the current tuning parameters may be initial or default tuning parameters. In some other examples, the current tuning parameters may be previously updated tuning parameters. In some aspects, the vehicle device 405 may update the current tuning parameters to the updated tuning parameters by estimating an update to the current tuning parameters based at least in part on the one or more estimated driver interaction parameters. In some aspects, in a case in which the one or more driver interaction parameters include one or more estimated tuning parameters, the vehicle device 405 may update the tuning parameters by combining or blending the tuning parameters estimated based on the driver interaction data with the current tuning parameters. In some aspects, in a case in which the one or more driver interaction parameters include one or more estimated tuning parameters, the vehicle device 405 may update the tuning parameters by changing (e.g., ramping) from the current tuning parameters to the tuning parameters estimated based on the driver interaction data.

In some aspects, the vehicle device 405 may update the tuning parameters responsive to one or more conditions associated with updating the tuning parameters. For example, in a case in which the driver interaction data is collected online while the vehicle is being driven, the vehicle device 405 may update the tuning parameters once in connection with a determination that a threshold amount of driver interaction data has been collected and used for estimating the driver interaction parameters. The threshold amount of driver interaction data may ensure that enough driver interaction data is collected to represent a current driving situation prior to updating the tuning parameters. Additionally, or alternatively, the vehicle device 405 may perform a sanity check on the updated tuning parameters (e.g., DIL parameters) by checking boundaries and/or compatibility with other DIL parameters. In this case, the vehicle device 405 may update the tuning parameters in connection with the updated tuning parameters passing the sanity check (e.g., the boundary check and/or the compatibility check).

As shown in FIG. 4B, and by reference number 425, the vehicle device 405 may cause the automated driving or driver assistance feature to be applied at the vehicle in accordance with the one or more updated tuning parameters. The vehicle device 405 may cause the automated driving or driver assistance feature to be applied at the vehicle in accordance with the one or more updated tuning parameters while the vehicle is being driven. In some aspects, in a case in which the vehicle device 405 is an on-board device or an on-board system of the vehicle, the vehicle device 405 may cause the automated driving or driver assistance feature to be applied at the vehicle in accordance with the one or more updated tuning parameters by controlling the automated driving or driver assistance feature based on the one or more updated tuning parameters.

FIG. 4B shows an example 430 of the vehicle device 405 controlling the automated driving or driver assistance feature based on the one or more updated tuning parameters. As shown by reference number 432, the vehicle device 405 may activate the automated driving or driver assistance feature. For example, the automated driving or driver assistance feature may be an automated or assisted steering feature that controls a lateral movement of the vehicle. As shown by reference number 434, the vehicle device 405 may monitor driver interaction data. The vehicle device 405 may obtain the driver interaction data one or more sensors. In some examples, the driver interaction data may include data relating to driver interaction with the steering wheel of the vehicle. For example, the driver interaction data may include measurements of steering wheel torque values applied by the driver on the steering wheel of the vehicle. In some examples, other driver interaction data may be monitored in addition to or instead of the steering wheel torque measurements.

As shown by reference number 436, the vehicle device 405 may detect passive or active driver interaction based on the driver interaction data and the one or more updated tuning parameters. The one or more updated tuning parameters may include one or more updated DIL tuning parameters for the automated driving or driver assistance feature. In some aspects, the one or more updated tuning parameters may include one or more updated thresholds, gains, integral parameters, derivative parameters, or rate limits associated with detecting active or passive interaction with the vehicle by a driver of the vehicle. The vehicle device 405 may detect passive interaction with the vehicle by the driver or active interaction with the vehicle by the driver by applying the one or more updated thresholds, gains, integral parameters, derivative parameters, or rate limits to the driver interaction data. In some aspects, the driver interaction data may include the measurements of steering wheel torque values applied by the driver on the steering wheel of the vehicle, and the one or more updated tuning parameters may include one or more updated thresholds, gains, integral parameters, derivative parameters, or rate limits associated with steering wheel torque based detection of active or passive interaction with the steering wheel of the vehicle by a driver of the vehicle. The vehicle device 405 may detect passive interaction with the steering wheel of the vehicle by the driver or active interaction with the steering wheel of the vehicle (e.g., active steering) by the driver by applying the one or more updated thresholds, gains, integral parameters, derivative parameters, or rate limits to measurements of steering wheel torque values applied by the driver.

As shown by reference number 438, the vehicle device 405 may transfer control of the vehicle between the automated driving or driver assistance feature and the driver of the vehicle based on detecting passive or active driver interaction. In a case in which the automated driving or driver assistance feature (e.g., the automated or assisted steering feature) is controlling the vehicle (e.g., controlling the lateral movement of the vehicle), and the vehicle device 405 detects active interaction of the driver with the vehicle (e.g., active steering by the driver) based on the updated tuning parameters and the driver interaction data, the vehicle device 405 may transfer control of the vehicle from the automated driving or driver assistance feature to the driver. For example, in this case, the vehicle device 405 may control a steering wheel torque applied by the automated driving or driver assistance feature to be ramped down. In a case in which the automated driving or driver assistance feature (e.g., the automated or assisted steering feature) is not controlling the vehicle (e.g., control of the vehicle has previously been transferred to the driver), and the vehicle device 405 detects passive interaction of the driver with the vehicle (e.g., with the steering wheel of the vehicle) based on the updated tuning parameters and the driver interaction data, the vehicle device 405 may transfer control of the vehicle to the automated driving or driver assistance feature (e.g. from the driver). For example, in this case, the vehicle device 405 may control a steering wheel torque applied by the automated driving or driver assistance feature to be ramped up.

In some aspects, in a case in which the vehicle device 405 is a remote device associated with the vehicle, the vehicle device 405 may cause the automated driving or driver assistance feature to be applied at the vehicle in accordance with the one or more updated tuning parameters by transmitting the updated tuning parameters (e.g., the updated DIL tuning parameters) to an on-board device or on-board system of the vehicle to be used by the on-board device or on-board system to control the automated driving or driver assistance feature. In this case, the on-board device or on-board system may control the automated driving or driver assistance feature as discussed above in connection with example 430.

As indicated above, FIGS. 4A-4B are provided as an example. Other examples may differ from what is described with respect to FIGS. 4A-4B.

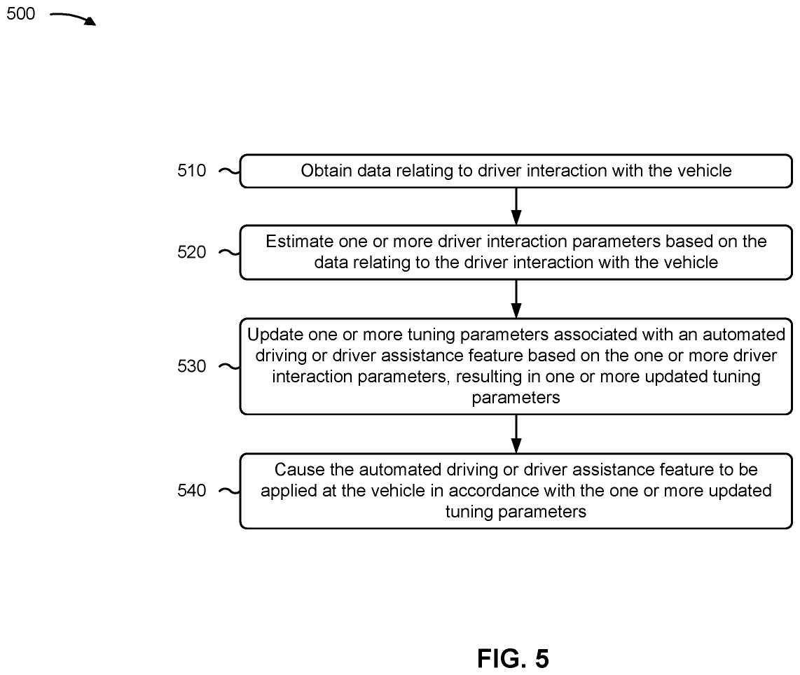

FIG. 5 is a flowchart of an example process 500 associated with estimation of driver interaction based tuning parameters for automated driving or driver assistance, in accordance with the present disclosure. In some aspects, one or more process blocks of FIG. 5 are performed by a device (e.g., vehicle device 405, on-board system 120, on-board system 200, or on-board device 208). In some aspects, one or more process blocks of FIG. 5 are performed by another device or a group of devices separate from or including the device, such as a remote device (e.g., remote device 130) and/or a network node (e.g., network node 150). Additionally, or alternatively, one or more process blocks of FIG. 5 may be performed by one or more components of device 300, such as processor 310, memory 315, input component 320, output component 325, communication component 330, and/or estimation component 335.

As shown in FIG. 5, process 500 may include obtaining data relating to driver interaction with the vehicle (block 510). For example, the device may obtain data relating to driver interaction with the vehicle, as described above.

As further shown in FIG. 5, process 500 may include estimating one or more driver interaction parameters based on the data relating to the driver interaction with the vehicle (block 520). For example, the device may estimate one or more driver interaction parameters based on the data relating to the driver interaction with the vehicle, as described above.

As further shown in FIG. 5, process 500 may include updating one or more tuning parameters associated with an automated driving or driver assistance feature based on the one or more driver interaction parameters, resulting in one or more updated tuning parameters (block 530). For example, the device may update one or more tuning parameters associated with an automated driving or driver assistance feature based on the one or more driver interaction parameters, resulting in one or more updated tuning parameters, as described above.

As further shown in FIG. 5, process 500 may include causing the automated driving or driver assistance feature to be applied at the vehicle in accordance with the one or more updated tuning parameters (block 540). For example, the device may cause the automated driving or driver assistance feature to be applied at the vehicle in accordance with the one or more updated tuning parameters, as described above.

Process 500 may include additional aspects, such as any single aspect or any combination of aspects described below and/or in connection with one or more other processes described elsewhere herein.

In a first aspect, obtaining the data relating to the driver interaction with the vehicle includes obtaining the data relating to the driver interaction with the vehicle via online data collection while the vehicle is being driven.

In a second aspect, alone or in combination with the first aspect, obtaining the data relating to the driver interaction with the vehicle via online data collection while the vehicle is being driven includes obtaining the data relating to the driver interaction with the vehicle via online data collection while the vehicle is being driven and the automated driving or driver assistance feature is not activated.

In a third aspect, alone or in combination with one or more of the first and second aspects, the data relating to the driver interaction with the vehicle includes at least one of driver steering data, braking input data, accelerator input data, or condition monitoring data.

In a fourth aspect, alone or in combination with one or more of the first through third aspects, process 500 includes categorizing the data relating to the driver interaction with the vehicle into a plurality of data sets associated with different respective driving scenarios.

In a fifth aspect, alone or in combination with one or more of the first through fourth aspects, categorizing the data relating to the driver interaction with the vehicle into a plurality of data sets associated with different driving scenarios includes categorizing the data relating to the driver interaction with the vehicle into the plurality of data sets based on at least one of whether or not the driver interaction with the vehicle is actively changing a motion of the vehicle, different road geometries, different speed ranges, different acceleration states of the vehicle, or different road or environment conditions.

In a sixth aspect, alone or in combination with one or more of the first through fifth aspects, estimating one or more driver interaction parameters based on the data relating to the driver interaction with the vehicle includes estimating respective driver interaction parameters for one or more data sets of the plurality of data sets.

In a seventh aspect, alone or in combination with one or more of the first through sixth aspects, obtaining the data relating to the driver interaction with the vehicle includes obtaining the data relating to the driver interaction with the vehicle via a vehicle-driver interaction sequence while the vehicle is stationary.

In an eighth aspect, alone or in combination with one or more of the first through seventh aspects, the one or more updated tuning parameters are associated with transferring control of the vehicle between the automated driving or driver assistance feature and a driver of the vehicle.

In a ninth aspect, alone or in combination with one or more of the first through eighth aspects, the data relating to driver interaction with the vehicle includes data relating to driver interaction with a steering wheel of the vehicle.

In a tenth aspect, alone or in combination with one or more of the first through ninth aspects, the one or more driver interaction parameters include one or more driver steering wheel torque values associated with active steering by a driver of the vehicle, and one or more driver steering wheel torque values associated with passive interaction with the steering wheel of the vehicle by the driver of the vehicle.

In an eleventh aspect, alone or in combination with one or more of the first through tenth aspects, one or more driver interaction parameters include one or more steering wheel torque thresholds, integrals, derivatives, or gains associated with detecting active or passive interaction with the steering wheel of the vehicle by a driver of the vehicle.

In a twelfth aspect, alone or in combination with one or more of the first through eleventh aspects, the one or more updated tuning parameters include one or more updated thresholds, gains, integral parameters, derivative parameters, or rate limits associated with steering wheel torque based detection of active or passive interaction with the steering wheel of the vehicle by a driver of the vehicle.

In a thirteenth aspect, alone or in combination with one or more of the first through twelfth aspects, causing the automated driving or driver assistance feature to be applied at the vehicle in accordance with the one or more updated tuning parameters includes at least one of transferring control of the vehicle from the automated driving or driver assistance feature to the driver of the vehicle in connection with detecting active interaction with the steering wheel of the vehicle based at least in part on the one or more updated thresholds, gains, integral parameters, derivative parameters, or rate limits, or transferring control of the vehicle to the automated driving or driver assistance feature in connection with detecting passive interaction with the steering wheel of the vehicle based at least in part on the one or more updated thresholds, gains, integral parameters, derivative parameters, or rate limits.

In a fourteenth aspect, alone or in combination with one or more of the first through thirteenth aspects, the one or more updated tuning parameters include one or more updated thresholds, gains, integral parameters, derivative parameters, or rate limits associated with detecting active or passive interaction with the vehicle by a driver of the vehicle.

In a fifteenth aspect, alone or in combination with one or more of the first through fourteenth aspects, causing the automated driving or driver assistance feature to be applied at the vehicle in accordance with the one or more updated tuning parameters includes at least one of transferring control of the vehicle from the automated driving or driver assistance feature to the driver of the vehicle in connection with detecting active interaction with the vehicle based at least in part on the updated thresholds, gains, integral parameters, derivative parameters, or rate limits, or transferring control of the vehicle to the automated driving or driver assistance feature in connection with detecting passive interaction with the vehicle based at least in part on the one or more updated thresholds, gains, integral parameters, derivative parameters, or rate limits.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method performed by a device associated with a vehicle, comprising: obtaining, by the device, data relating to driver interaction with the vehicle; estimating, by the device, one or more driver interaction parameters based on the data relating to the driver interaction with the vehicle; updating, by the device, one or more tuning parameters associated with an automated driving or driver assistance feature based on the one or more driver interaction parameters, resulting in one or more updated tuning parameters; and causing, by the device, the automated driving or driver assistance feature to be applied at the vehicle in accordance with the one or more updated tuning parameters.

Aspect 2: The method of Aspect 1, wherein obtaining the data relating to the driver interaction with the vehicle comprises: obtaining the data relating to the driver interaction with the vehicle via online data collection while the vehicle is being driven.

Aspect 3: The method of Aspect 2, wherein obtaining the data relating to the driver interaction with the vehicle via online data collection while the vehicle is being driven comprises: obtaining the data relating to the driver interaction with the vehicle via online data collection while the vehicle is being driven and the automated driving or driver assistance feature is not activated.

Aspect 4: The method of any of Aspects 2-3, wherein the data relating to the driver interaction with the vehicle includes at least one of: driver steering data, brake input data, accelerator input data, or driver condition monitoring data.

Aspect 5: The method of any of Aspects 2-4, further comprising: categorizing the data relating to the driver interaction with the vehicle into a plurality of data sets associated with different respective driving scenarios.

Aspect 6: The method of Aspect 5, wherein categorizing the data relating to the driver interaction with the vehicle into a plurality of data sets associated with different driving scenarios comprises: categorizing the data relating to the driver interaction with the vehicle into the plurality of data sets based on at least one of: whether or not the driver interaction with the vehicle is actively changing a motion of the vehicle, different road geometries, different speed ranges, different acceleration states of the vehicle, or different road or environment conditions.

Aspect 7: The method of any of Aspects 5-6, wherein estimating one or more driver interaction parameters based on the data relating to the driver interaction with the vehicle comprises: estimating respective driver interaction parameters for one or more data sets of the plurality of data sets.

Aspect 8: The method of Aspect 1, wherein obtaining the data relating to the driver interaction with the vehicle comprises: obtaining the data relating to the driver interaction with the vehicle via a vehicle-driver interaction sequence while the vehicle is stationary.

Aspect 9: The method of any of Aspects 1-8, wherein the one or more updated tuning parameters are associated with transferring control of the vehicle between the automated driving or driver assistance feature and a driver of the vehicle.

Aspect 10: The method of any of Aspects 1-9, wherein the data relating to driver interaction with the vehicle includes data relating to driver interaction with a steering wheel of the vehicle.

Aspect 11: The method of Aspect 10, wherein the one or more driver interaction parameters include: one or more driver steering wheel torque values associated with active steering by a driver of the vehicle, and one or more driver steering wheel torque values associated with passive interaction with the steering wheel of the vehicle by the driver of the vehicle.

Aspect 12: The method of any of Aspects 10-11, wherein one or more driver interaction parameters include one or more steering wheel torque thresholds, integrals, derivatives, or gains associated with detecting active or passive interaction with the steering wheel of the vehicle by a driver of the vehicle.

Aspect 13: The method of any of Aspects 10-12, wherein the one or more updated tuning parameters include one or more updated thresholds, gains, integral parameters, derivative parameters, or rate limits associated with steering wheel torque based detection of active or passive interaction with the steering wheel of the vehicle by a driver of the vehicle.

Aspect 14: The method of Aspect 13, wherein causing the automated driving or driver assistance feature to be applied at the vehicle in accordance with the one or more updated tuning parameters comprises at least one of: transferring control of the vehicle from the automated driving or driver assistance feature to the driver of the vehicle in connection with detecting active interaction with the steering wheel of the vehicle based at least in part on the one or more updated thresholds, gains, integral parameters, derivative parameters, or rate limits; or transferring control of the vehicle to the automated driving or driver assistance feature in connection with detecting passive interaction with the steering wheel of the vehicle based at least in part on the one or more updated thresholds, gains, integral parameters, derivative parameters, or rate limits.

Aspect 15: The method of any of Aspects 1-14, wherein the one or more updated tuning parameters include one or more updated thresholds, gains, integral parameters, derivative parameters, or rate limits associated with detecting active or passive interaction with the vehicle by a driver of the vehicle.

Aspect 16: The method of Aspect 15, wherein causing the automated driving or driver assistance feature to be applied at the vehicle in accordance with the one or more updated tuning parameters comprises at least one of: transferring control of the vehicle from the automated driving or driver assistance feature to the driver of the vehicle in connection with detecting active interaction with the vehicle based at least in part on the updated thresholds, gains, integral parameters, derivative parameters, or rate limits; or transferring control of the vehicle to the automated driving or driver assistance feature in connection with detecting passive interaction with the vehicle based at least in part on the one or more updated thresholds, gains, integral parameters, derivative parameters, or rate limits.

Aspect 17: A system configured to perform one or more operations recited in one or more of Aspects 1-16.

Aspect 18: An apparatus comprising means for performing one or more operations recited in one or more of Aspects 1-16.

Aspect 19: A non-transitory computer-readable medium storing a set of instructions, the set of instructions comprising one or more instructions that, when executed by a device, cause the device to perform one or more operations recited in one or more of Aspects 1-16.

Aspect 20: A computer program product comprising instructions or code for executing one or more operations recited in one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device associated with a vehicle, the device comprising:
one or more memories; and
one or more processors, coupled to the one or more memories, configured to cause the device to:
obtain data relating to driver interaction with the vehicle;
estimate one or more driver interaction parameters based on the data relating to the driver interaction with the vehicle;
update one or more tuning parameters associated with an automated driving or driver assistance feature based on the one or more driver interaction parameters, resulting in one or more updated tuning parameters; and
cause the automated driving or driver assistance feature to be applied at the vehicle in accordance with the one or more updated tuning parameters.

2. The device of claim Error! Reference source not found., wherein the one or more processors, to cause the device to obtain the data relating to the driver interaction with the vehicle, are configured to cause the device to:
obtain the data relating to the driver interaction with the vehicle via online data collection while the vehicle is being driven.

3. The device of claim Error! Reference source not found., wherein the one or more processors, to cause the device to obtain the data relating to the driver interaction with the vehicle via online data collection while the vehicle is being driven, are configured to cause the device to:
obtain the data relating to the driver interaction with the vehicle via online data collection while the vehicle is being driven and the automated driving or driver assistance feature is not activated.

4. The device of claim Error! Reference source not found., wherein the data relating to the driver interaction with the vehicle includes at least one of:
driver steering data,
brake input data,
accelerator input data, or
driver condition monitoring data.

5. The device of claim Error! Reference source not found., wherein the one or more processors are further configured to cause the device to:
categorize the data relating to the driver interaction with the vehicle into a plurality of data sets associated with different respective driving scenarios.

6. The device of claim Error! Reference source not found., wherein the one or more processors, to cause the device to categorize the data relating to the driver interaction with the vehicle into a plurality of data sets associated with different driving scenarios, are configured to cause the device to:
categorize the data relating to the driver interaction with the vehicle into the plurality of data sets based on at least one of:
whether or not the driver interaction with the vehicle is actively changing a motion of the vehicle,
different road geometries,
different speed ranges,
different acceleration states of the vehicle, or
different road or environment conditions.

7. The device of claim Error! Reference source not found., wherein the one or more processors, to cause the device to estimate one or more driver interaction parameters based on the data relating to the driver interaction with the vehicle, are configured to cause the device to:
estimate respective driver interaction parameters for one or more data sets of the plurality of data sets.

8. The device of claim Error! Reference source not found., wherein the one or more processors, to cause the device to obtain the data relating to the driver interaction with the vehicle, are configured to cause the device to:
obtain the data relating to the driver interaction with the vehicle via a vehicle-driver interaction sequence while the vehicle is stationary.

9. The device of claim Error! Reference source not found., wherein the one or more updated tuning parameters are associated with transferring control of the vehicle between the automated driving or driver assistance feature and a driver of the vehicle.

10. The device of claim Error! Reference source not found., wherein the data relating to driver interaction with the vehicle includes data relating to driver interaction with a steering wheel of the vehicle.

11. The device of claim Error! Reference source not found., wherein the one or more driver interaction parameters include:
one or more driver steering wheel torque values associated with active steering by a driver of the vehicle, and
one or more driver steering wheel torque values associated with passive interaction with the steering wheel of the vehicle by the driver of the vehicle.

12. The device of claim Error! Reference source not found., wherein one or more driver interaction parameters include one or more steering wheel torque thresholds, integrals, derivatives, or gains associated with detecting active or passive interaction with the steering wheel of the vehicle by a driver of the vehicle.

13. The device of claim Error! Reference source not found., wherein the one or more updated tuning parameters include one or more updated thresholds, gains, integral parameters, derivative parameters, or rate limits associated with steering wheel torque based detection of active or passive interaction with the steering wheel of the vehicle by a driver of the vehicle.

14. The device of claim Error! Reference source not found., wherein the one or more processors, to cause the device to cause the automated driving or driver assistance feature to be applied at the vehicle in accordance with the one or more updated tuning parameters, are configured to cause the device to:
transfer control of the vehicle from the automated driving or driver assistance feature to the driver of the vehicle in connection with detecting active interaction with the steering wheel of the vehicle based at least in part on the one or more updated thresholds, gains, integral parameters, derivative parameters, or rate limits; or
transfer control of the vehicle to the automated driving or driver assistance feature in connection with detecting passive interaction with the steering wheel of the vehicle based at least in part on the one or more updated thresholds, gains, integral parameters, derivative parameters, or rate limits.

15. The device of claim Error! Reference source not found., wherein the one or more updated tuning parameters include one or more updated thresholds, gains, integral parameters, derivative parameters, or rate limits associated with detecting active or passive interaction with the vehicle by a driver of the vehicle.

16. The device of claim Error! Reference source not found., wherein the one or more processors, to cause the device to cause the automated driving or driver assistance feature to be applied at the vehicle in accordance with the one or more updated tuning parameters, are configured to cause the device to:
transfer control of the vehicle from the automated driving or driver assistance feature to the driver of the vehicle in connection with detecting active interaction with the vehicle based at least in part on the updated thresholds, gains, integral parameters, derivative parameters, or rate limits; or
transfer control of the vehicle to the automated driving or driver assistance feature in connection with detecting passive interaction with the vehicle based at least in part on the one or more updated thresholds, gains, integral parameters, derivative parameters, or rate limits.

17. A method performed by a device associated with a vehicle, comprising:
obtaining, by the device, data relating to driver interaction with the vehicle;
estimating, by the device, one or more driver interaction parameters based on the data relating to the driver interaction with the vehicle;
updating, by the device, one or more tuning parameters associated with an automated driving or driver assistance feature based on the one or more driver interaction parameters, resulting in one or more updated tuning parameters; and
causing, by the device, the automated driving or driver assistance feature to be applied at the vehicle in accordance with the one or more updated tuning parameters.

18. The method of claim 17, wherein obtaining the data relating to the driver interaction with the vehicle comprises:
obtaining the data relating to the driver interaction with the vehicle via online data collection while the vehicle is being driven.

19. The method of claim 18, wherein obtaining the data relating to the driver interaction with the vehicle via online data collection while the vehicle is being driven comprises:
obtaining the data relating to the driver interaction with the vehicle via online data collection while the vehicle is being driven and the automated driving or driver assistance feature is not activated.

20. The method of claim 18, wherein the data relating to the driver interaction with the vehicle includes at least one of:
driver steering data,
brake input data,
accelerator input data, or
driver condition monitoring data.

21. The method of claim 18, further comprising:
categorizing the data relating to the driver interaction with the vehicle into a plurality of data sets associated with different respective driving scenarios.

22. The method of claim 21, wherein categorizing the data relating to the driver interaction with the vehicle into a plurality of data sets associated with different driving scenarios comprises:
categorizing the data relating to the driver interaction with the vehicle into the plurality of data sets based on at least one of:
whether or not the driver interaction with the vehicle is actively changing a motion of the vehicle,
different road geometries,
different speed ranges,
different acceleration states of the vehicle, or
different road or environment conditions.

23. The method of claim 21, wherein estimating one or more driver interaction parameters based on the data relating to the driver interaction with the vehicle comprises:
estimating respective driver interaction parameters for one or more data sets of the plurality of data sets.

24. The method of claim 17, wherein obtaining the data relating to the driver interaction with the vehicle comprises:
obtaining the data relating to the driver interaction with the vehicle via a vehicle-driver interaction sequence while the vehicle is stationary.

25. The method of claim 17, wherein the one or more updated tuning parameters are associated with transferring control of the vehicle between the automated driving or driver assistance feature and a driver of the vehicle.

26. The method of claim 17, wherein the data relating to driver interaction with the vehicle includes data relating to driver interaction with a steering wheel of the vehicle.

27. The method of claim 17, wherein the one or more updated tuning parameters include one or more updated thresholds, gains, integral parameters, derivative parameters, or rate limits associated with detecting active or passive interaction with the vehicle by a driver of the vehicle.

28. The method of claim 27, wherein causing the automated driving or driver assistance feature to be applied at the vehicle in accordance with the one or more updated tuning parameters comprises at least one of:
transferring control of the vehicle from the automated driving or driver assistance feature to the driver of the vehicle in connection with detecting active interaction with the vehicle based at least in part on the updated thresholds, gains, integral parameters, derivative parameters, or rate limits; or
transferring control of the vehicle to the automated driving or driver assistance feature in connection with detecting passive interaction with the vehicle based at least in part on the one or more updated thresholds, gains, integral parameters, derivative parameters, or rate limits.

29. A non-transitory computer-readable medium storing a set of instructions, the set of instructions comprising:
one or more instructions that, when executed by one or more processors of a device associated with a vehicle, cause the device to:
obtain data relating to driver interaction with the vehicle;
estimate one or more driver interaction parameters based on the data relating to the driver interaction with the vehicle;
update one or more tuning parameters associated with an automated driving or driver assistance feature based on the one or more driver interaction parameters, resulting in one or more updated tuning parameters; and
cause the automated driving or driver assistance feature to be applied at the vehicle in accordance with the one or more updated tuning parameters.

30. An apparatus for wireless communication, comprising:
means for obtaining data relating to driver interaction with a vehicle;
means for estimating one or more driver interaction parameters based on the data relating to the driver interaction with the vehicle;
means for updating one or more tuning parameters associated with an automated driving or driver assistance feature based on the one or more driver interaction parameters, resulting in one or more updated tuning parameters; and
means for causing the automated driving or driver assistance feature to be applied at the vehicle in accordance with the one or more updated tuning parameters.
